(19) United States
(12) Patent Application Publication
(10) Pub. No.: US 2010/0061276 A1
(43) Pub. Date: Mar. 11, 2010

(54) Dedicated Call User Interface (UI) for Organizing Collaborative Exchange During A Telephony or Softphone Call

(75) Inventors: Dalia M. Havens, Cedar Park, TX (US); Jessica W. Ramirez, Danbury, CT (US); Tracee V. Wolf, Ossining, NY (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/206,134

(22) Filed: Sep. 8, 2008

(51) Int. Cl. H04L 12/16

(52) U.S. Cl. 370/260

(57) ABSTRACT

A method is provided for executing and organizing collaborative exchange during a telephone call utilizing a user interface (UI). A telephone call is placed, such that participants are connected. Audible content transmitted and received over a network for the telephone call. A user interface, representing the telephone call itself, is provided and is configured to allow collaborative exchange among participants of the telephone call. The telephone call is placed without having to set up a meeting session to facilitate collaborative exchange or without having to set up a web conference to facilitate collaborative exchange. The telephone call is placed without having to schedule in advance to allow for collaborative exchange. The user interface provides real time collaboration tools for collaboration exchange, and the collaboration tools do not have to be set up in advance.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

Exemplary embodiments relate to communications and particularly to communications which provide a user interface for collaborative exchange during a call.

2. Description of Background

Currently, voice communication sessions (such as calling parties involving telephone(s) and softphone(s)) that leverage the computer as a supplementary collaborative device are typically supported by web conferences and, in an increasing venue, instant messaging applications. However, designing a dedicated call user interface (UI) that focuses on voice as the primary mode of communication while providing a supplementary computer collaborative experience has received less successful attention.

The coordination and integration of calling as a form of collaboration along with an instant messaging (IM) application has an awkward relationship with the instant messaging and collaboration tools within that application. It is not uncommon to reuse the chat window for a voice communication session (such as adding call controls to the participant list with the chat transcript as an attached portion of the window). In this type of situation, the chat application is treated as the primary mode of communication and the voice call is appended as a nested kind of experience. Some applications such as Skype do not treat the calling communication as a nested form of IM, yet it struggles to maintain a relationship between the call UI and other collaborative activities (such as instant messaging and screen sharing).

The undesirable consequences we are left with are: integrating the call and chat into one window which assumes the necessity of chat even if the chat is not being used; and not integrating the call and chat into one window which leaves the end user to try to keep track of the multiple windows and associate them as part of the same collaboration session with the calling party.

Web conferences provide a somewhat realistic solution to integrating and organizing computer-oriented collaborations for a given voice session. However, web conferences tend to be difficult to get started and use (heavy weight), they do not always have audio integration, and they assume a specific set of fixed collaboration tools. Web conferences require some prior notice to the participants (scheduling and coordination), reducing its potential for flexible, ad hoc interactions. Web conferences supplement a telephone call or other audio session but web conferences often are not coordinated with the audio session in terms of providing audio support/controls via the interface.

Without a user interface (UI) dedicated to the calling activity where collaborative tools are organized around that activity, end users continue to struggle to coordinate and use these disparate collaborative technologies.

### SUMMARY OF EXEMPLARY EMBODIMENTS

In accordance with exemplary embodiments, a method is provided for executing and organizing collaborative exchange during a voice communication session utilizing a user interface (UI). A voice call is placed, such that participants are connected. Audible content is transmitted and received over a network for the telephone call. A user interface, representing the voice call itself, is provided and is configured to allow collaborative exchange among participants of the call. The voice session is established without having to schedule in advance to allow for collaborative exchange. The user interface provides real time collaboration tools for collaboration exchange, and the collaboration tools do not have to be set up in advance.

System and computer program products corresponding to the above-summarized methods are also described herein.

Additional features are realized through the techniques of the present invention. Exemplary embodiments are described in detail herein and are considered a part of the claimed invention. For a better understanding of features, refer to the description and to the drawings.

### BRIEF DESCRIPTION OF SEVERAL VIEWS OF THE DRAWINGS

The subject matter which is regarded as the invention is particularly pointed out and distinctly claimed in the claims at the conclusion of the specification. The foregoing and other features are apparent from the following detailed description taken in conjunction with the accompanying drawings in which:

FIG. 1 illustrates an example of a computing device having capabilities, which may be utilized by exemplary embodiments;

FIG. 2 illustrates a system in which exemplary embodiments may be implemented;

FIG. 3 illustrates an example of a user interface screen in accordance with exemplary embodiments; and

FIG. 4 illustrates a method for executing and organizing collaborative exchange during a voice call utilizing a user interface (UI) in accordance with exemplary.

The detailed description explains exemplary embodiments, together with features, by way of example with reference to the drawings.

### DETAILED DESCRIPTION OF EXEMPLARY EMBODIMENTS

Exemplary embodiments provide a lightweight entry point and dedicated user interface (UI) for a telephone call (or other voice communication session such as computer-to-computer or soft phone connection) that allows for additional collaborative tools to be easily accessed if needed, as well as the ability to associate numerous collaboration windows with that telephone call session. We start with the premise that the audio session is the primary mode of communication for that group, and other collaborative tools supplement that communication and can be invoked when needed. The set of collaboration tools do not need to be a fixed set or predetermined, and set of collaboration tools could be extensible.

Exemplary embodiments describe how these supplementary forms of collaboration are associated and managed from the call UI via a timeline or similar organizing mechanism which shows and organizes collaborative events during the call (it need not even be a ‘timeline’ but could be a general ‘bucket’ or a series of tabs on the UI that collect collaborative events and thumbnails). In accordance with exemplary embodiments, the timeline itself provides a cohesive call experience that reduces the burdens of the technology to that group; members of the call use the timeline or other equivalent organizing feature of the UI to organize multi-media communication as opposed to using separate applications.

In accordance with exemplary embodiments, participants can appreciate having a dedicated call UI that allows additional modes of collaborations to be associated with the call UI because the participants of the calling party need not predetermine or reserve collaboration tools. When collaboration tools are actually used, the collaboration tools are represented in the main call UI with the ability to manage the various windows in use for that calling party (i.e., a shared file may have its own window but is represented and invoked from the call UI). Also, the design of the call UI need not account for scaling issues required of the data being shared, because collaborative data is contained outside of the call UI window as per the specifications of the collaborative tool and per the viewing needs of that collaborative data. The call UI is configured to represent the shared data in a way that helps the participants easily account for all the shared material during the session (and even as a historical account after the session has transpired).

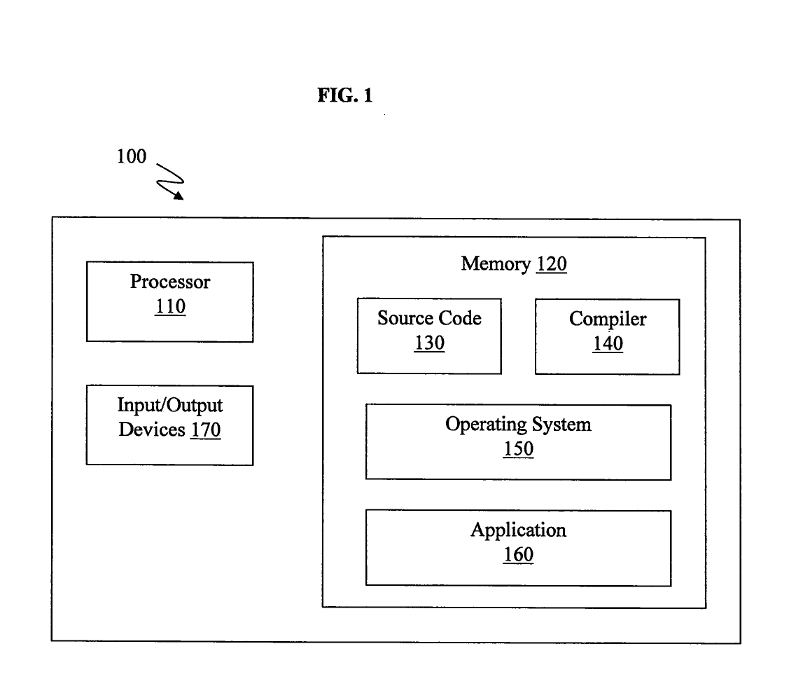

FIG. 1 illustrates an example of a computing device 100 having capabilities, which may be utilized by exemplary embodiments. Various operations discussed herein may also utilize the capabilities of the computing device 100. One or more of the capabilities of the computing device 100 may be incorporated in any element, module, application, and/or component discussed herein.

The computing device 100 includes, but is not limited to, PCs, workstations, laptops, PDAs, palm devices, servers, storages, communication devices, telephones, and the like. Generally, in terms of hardware architecture, the computing device 100 may include one or more processors 110, memory 120, and one or more input and/or output (I/O) devices 170 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 110 is a hardware device for executing software that can be stored in the memory 120. The processor 110 can be virtually any custom made or commercially available processor, a central processing unit (CPU), a data signal processor (DSP), or an auxiliary processor among several processors associated with the computing device 100, and the processor 110 may be a semiconductor based microprocessor (in the form of a microchip) or a macroprocessor.

The memory 120 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 120 may incorporate electronic, magnetic, optical, and/or other types of storage media. Note that the memory 120 can have a distributed architecture, where various components are situated remote from one another, but can be accessed by the processor 110.

The software in the memory 120 may include one or more separate programs, each of which comprises an ordered listing of executable instructions for implementing logical functions. The software in the memory 120 includes a suitable operating system (O/S) 150, compiler 140, source code 130, and application 160 in accordance with exemplary embodiments. As illustrated, the application 160 comprises numerous functional components for implementing the features and operations of the exemplary embodiments. The application 160 of the computing device 100 may represent various applications, computational units, logic, functional units, processes, operations, virtual entities, and/or modules in accordance with exemplary embodiments, but the application 160 is not meant to be a limitation.

The operating system 150 controls the execution of other computer programs, and provides scheduling, input-output control, file and data management, memory management, and communication control and related services. It is contemplated by the inventors that the application 160 for implementing exemplary embodiments may be applicable on all commercially available operating systems.

The application 160 may be a source program, executable program (object code), script, or any other entity comprising a set of instructions to be performed. When a source program, then the program is usually translated via a compiler (such as the compiler 140), assembler, interpreter, or the like, which may or may not be included within the memory 120, so as to operate properly in connection with the O/S 150. Furthermore, the application 160 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 170 may include input devices such as, for example but not limited to, a mouse, keyboard, scanner, microphone, camera, etc. Furthermore, the I/O devices 170 may also include output devices, for example but not limited to a printer, display, etc. Finally, the I/O devices 170 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 170 also include components for communicating over various networks, such as the Internet or intranet.

If the computing device 100 is a PC, workstation, intelligent device or the like, the software in the memory 120 may further include a basic input output system (BIOS) (omitted for simplicity). The BIOS is a set of essential software routines that initialize and test hardware at startup, start the O/S 150, and support the transfer of data among the hardware devices. The BIOS is stored in some type of read-only-memory, such as ROM, PROM, EPROM, EEPROM or the like, so that the BIOS can be executed when the computing device 100 is activated.

When the computing device 100 is in operation, the processor 110 is configured to execute software stored within the memory 120, to communicate data to and from the memory 120, and to generally control operations of the computing device 100 pursuant to the software. The application 160 and the O/S 150 are read, in whole or in part, by the processor 110, perhaps buffered within the processor 110, and then executed.

When the application 160 is implemented in software it should be noted that the application 160 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 160 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 160 is implemented in hardware, the application 160 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

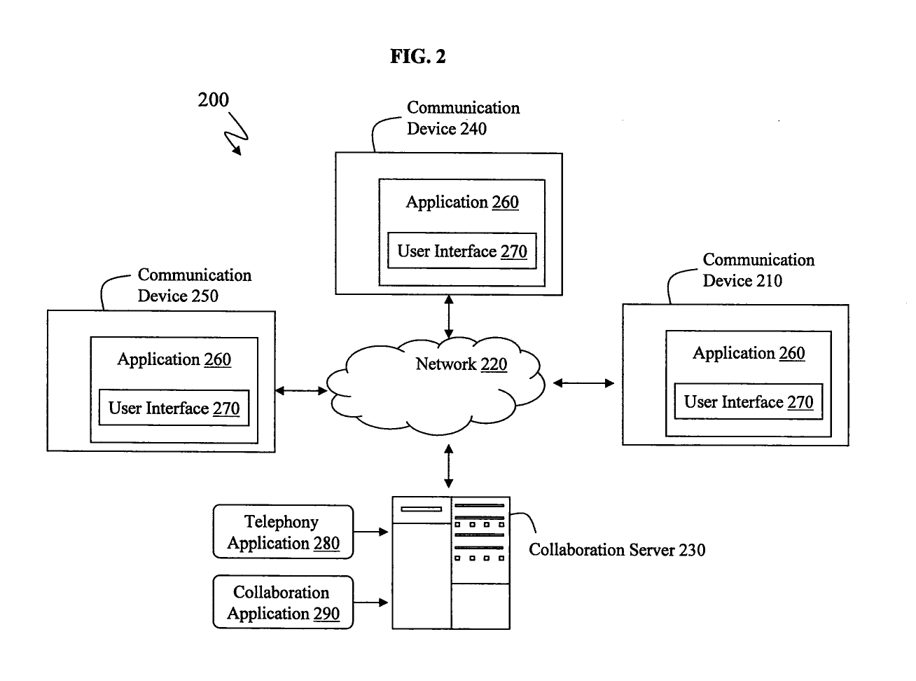

FIG. 2 illustrates a system 200 in which exemplary embodiments may be implemented. The system 200 may include one or more communication devices 210. The system 200 may also include communication device 240, communication device 250, and additional communication devices. The communication devices 210, 240, and 250 are operatively connected to a network 220. The communication devices 210, 240, and 250 may also include an antenna or a physical medium (such as a cable) for communicating over the network 220.

Additionally, the network 220 may include circuit-switched and/or packet-switched technologies and devices, such as routers, switches, hubs, gateways, etc., for facilitating communications. The network 220 can include the public switched telephone network (PSTN). The network 220 may include wireline and/or wireless components utilizing, e.g., IEEE 802.11 standards for providing over-the-air transmissions of communications. The network 220 can include IP-based networks for communication between a customer service center and clients/users. The network 220 can be representative of countless networks.

In exemplary embodiments, the network 220 can be a managed IP network administered by a service provider, which can control bandwidth and quality of service for the communications discussed herein. The network 220 may be implemented in a wireless fashion, e.g., using wireless protocols and technologies, such as WiFi, WiMax, BLUETOOTH, etc. The network 220 can also be a packet-switched network as a local area network, a wide area network, a metropolitan area network, an Internet network, or other similar types of networks. The network 220 may be a cellular communications network, a fixed wireless network, a wireless local area network (LAN), a wireless wide area network (WAN), a personal area network (PAN), a virtual private network (VPN), an intranet or any other suitable network, and the network 220 may include equipment for receiving and transmitting signals, such as a cell tower, a mobile switching center, a base station, and a wireless access point.

The communication devices 210, 240, and 250 may incorporate any features of the computing device 100. The communication devices 210, 240, and 250 may each include an application 260, and the application 260 may include any features of the application 160 of FIG. 1. The application 260 may include and/or be integrated with a user interface (module) 270, or the user interface 270 may be separate from the application 260. The communication devices 210, 240, and 250 may operatively connect to one or more servers, such as a collaboration server 230, via the network 220. The collaboration server 230 includes a telephony application 280 and a collaboration application 290. Although not shown, the collaboration server 230 may include the application 260 and/or the user interface 270, and can function accordingly. The collaboration server 230 may be in communication with other servers to facilitate exemplary embodiments.

The user of the communication device 210 may place a voice call to the user of the communication device 240 and/or the user of the communication device 250, or vice versa. The voice call may be operatively connected via the collaboration server 230 or any other telephone entity. The telephony application 280 of the collaboration server 230 is configured to connect the users of the communication devices 210, 240, and 250 (along with any other users), and the users can talk to each other over their respective communication devices 210, 240, and 250. At any time, any of the users of the communication devices 210, 240, and/or 250 may utilize his or her respective user interface 270 to operate collaborative tools to initiate collaborative exchange without having to schedule a session in advance. In response to initiating collaborative tools of the user interface 270, the collaboration application 290 of the collaboration server 230 may transmit a message to notify recipients that a collaborative exchange is about to take place. Collaborative exchange can take place immediately (for each of the users) through the collaboration application 290 of the collaboration server 230, without an interruption to voice exchange via the telephony application 280. Moreover, at anytime during voice exchange, the users (of the communication devices 210, 240, and 250) can utilize their respective user interface 270 to start collaboration tools for collaboration exchange via the collaboration application 290 of the collaboration server 230.

Furthermore, exemplary embodiments are not limited to but are capable of being implemented in the system 200 illustrated in FIG. 2. Additionally, the collaboration server 230 in FIG. 2 may be representative of numerous servers. The communication devices 210, 240, and 250 may be representative of numerous communication devices, including but not limited to telephone, cell phones, PDAs, computers, soft phones, etc. The application 260, the user interface 270, the telephony application 280, and the collaboration application 290 may be representative of numerous application, modules, instructions, etc. Therefore, the system 200 illustrated in FIG. 2 is neither limited numerically to the elements depicted therein nor limited to the exact configuration and operative connections of elements. Further, it is understood by those skilled in the art that elements may be added to, subtracted from, or substituted for the elements described in FIG. 2.

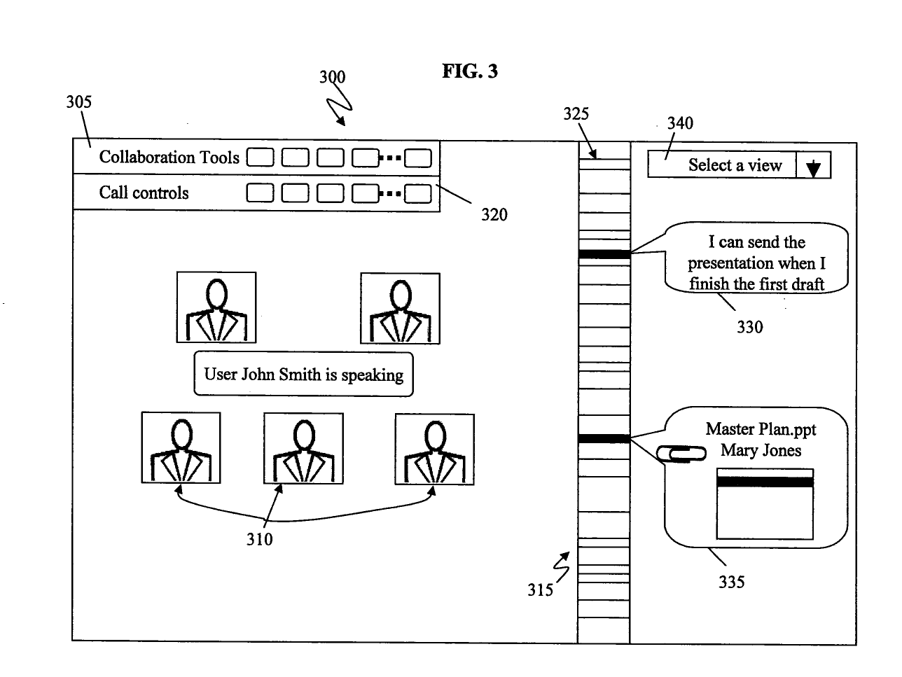

FIG. 3 illustrates an example of a user interface screen 300 in accordance with exemplary embodiments. The user interface screen 300 may be implemented using the user interface module 270 of the application 260.

FIG. 3 illustrates how supplementary forms of collaboration are associated and managed from the user interface screen 300. Along with a representation of call participants 310 and relevant call controls 320 (which are not the focus of this disclosure), the user interface screen 300 provides a call ‘timeline’ 315 or similar organizing mechanism to provide an overview of collaborative data. Collaborative data (or collaborative events) is data that was generated using the collaborative tools 305 and shared among the call participants 310 during the audio session. This collaborative organizing mechanism (such as the timeline 315) provides an overview of various events and shared materials such as participant status (speaking, going on mute, joining/leaving, etc.), transferring files, posting to a group chat transcript, and sharing screen ‘snapshots’. When any participant 310 of the call uses any of the extensible collaboration tools 305, a tick 325 may appear on the timeline 315, indicating use of that collaboration tool 305 and a representation of the participant's 310 use of the particular collaboration tool 305. For example, if the participant posted an instant messaging or messenger (IM) message, the timeline 325 record would show that IM message, e.g., the IM message 330. If a participant 310 transferred a file, the timeline 315 record would show a thumbnail of that file, e.g., the transferred file 335.

The type of realtime collaboration tools 305 leveraged by the user interface 270 could be extensible and vary by deployment. For example, IBM and/or business partners could build collaboration tools 305 to meet specific collaboration needs. Use of any of these tools could be tracked and recorded for possible service billing. The timeline 315 or other organizing mechanism records tool usage for the participants in that session.

The timeline events (which can be depicted as ticks 325) can be browsed by passing the cursor over the timeline 315, or timeline events can be filtered according to type of event, thus providing a contextual view of the collective communication modes conducted during the meeting. Thumbnails of the collaborative materials are shown to increase the usefulness of the overview (thumbnails such as the transferred file 335 can show a powerpoint file). Information accompanies the shared material, such as who shared it, when, name of file, etc. Participants 310 can open/access any of the shared materials by clicking on the thumbnail to launch the shared material (e.g., the transferred file 335) in its own window (as opposed to trying to fit it in the same window as a web conference would do).

View options 340 may include events associated with the call (i.e., people connecting, disconnecting) or use of any of the extensible collaboration tools 305. The view options 340 may also include selections for the following: new window, chat transcript, participant events, transferred files, announcements, screen captures, etc. Moreover, the view options 340 can be selected to show the entire chat transcript occurring during the voice call. Each event (like the IM message 330) of the chat transcript would correspond to one of the ticks 325 of the timeline 315. Similarly, the view options 340 can be selected to show the entire list of transferred files. Each event (like the transferred file 335) of the transferred files would correspond to one of the ticks 325 of the timeline 315.

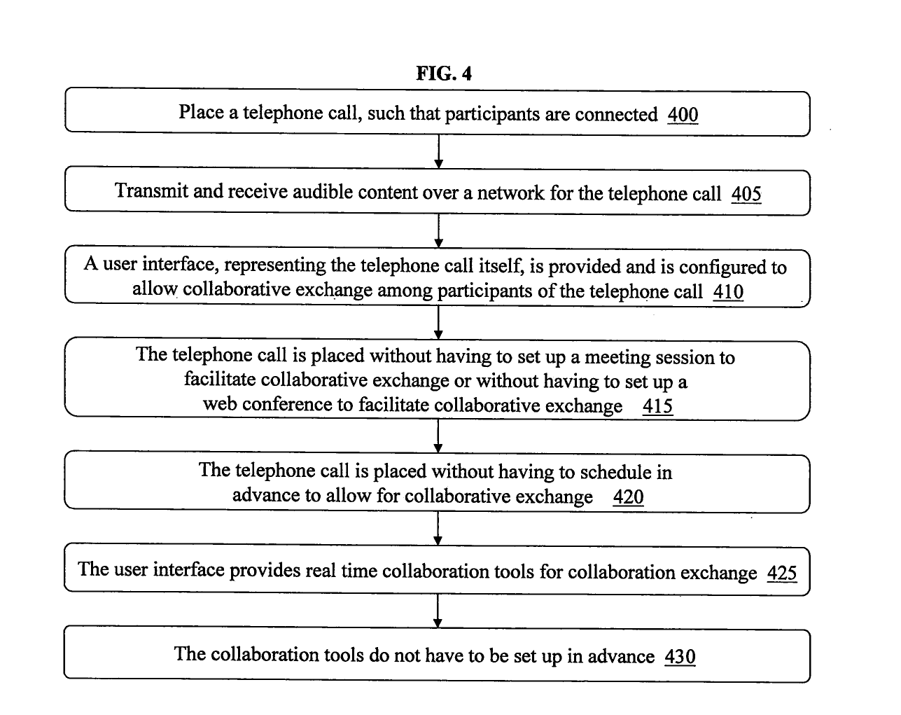

FIG. 4 illustrates a method for executing and organizing collaborative exchange during a telephone call utilizing a user interface (UI) in accordance with exemplary.

A telephone call may be placed via the telephone application 280 and/or the collaboration application 290, such that participants are connected at 400.

Audible content can be transmitted and received over a network (such as for the telephone call at 405. The call may be placed to connect communication devices 210, 240, and 250 via the telephony application 280 and/or the collaboration application 290 of the collaboration server 230. Also, the call may be placed and connected via the PSTN.

The user interface 270, representing the telephone call itself, is provided and is configured to allow collaborative exchange among participants of the telephone call at 410. The user interface 270 may display the user interface screen 300.

The telephone call is placed without having to set up a meeting session to facilitate collaborative exchange or without having to set up a web conference to facilitate collaborative exchange at 415.

The telephone call is placed without having to schedule in advance to allow for collaborative exchange at 420.

The user interface 270 provides real time collaboration tools 305 for collaboration exchange at 425.

The collaboration tools 305 do not have to be set up in advance at 430.

As discussed herein, the collaboration server 230 may include the telephony application 280 and/or the collaboration application 290. When a call is placed, the collaboration application 290 is immediately available to execute instructions of the user interface 270 for collaborative exchange, and the collaborative exchange may be initiated and operated using the collaboration tools 305 of the user interface 270.

For each telephone call that is placed, the user interface 270 provides real time collaboration tools 305 that do not have to be set up in advance. The user interface 270 comprises a timeline 315 having a plurality of indications (such as the ticks 325), where each of the indications is a collaborative event.

Collaborative exchange utilizing the user interface does not require the participants to call-in for collaborative exchange. The users do not have to set up an arrangement in advance to use collaborative tools for collaborative exchange during a telephone call.

In accordance with exemplary embodiments, the collaboration tools 305 are intrinsically linked to the telephone call. The collaboration tools 305 that are made available in the call UI are specifically available to the set of people in the call (initiating any supplemental communication or sharing any media does not require the end user to define what set of people to share it with; those on the call are automatically targeted as recipients). Furthermore, once collaboration tools 305 are invoked, the subsequent window(s) produced are associated with the call UI so that multiple windows can be minimized, maximized, and potentially moved in concert. Moreover, during a voice call, participants find that a few extra tools (such as the collaboration tools 305) make for a more productive experience, and in accordance with exemplary embodiments, only the tools used and needed will be added to the call UI. Collaboration tools 305 such as file transfer, chat, and screen-sharing provide for a more efficient call where the participants can fully engage without requiring an external client, such as their mail system. Since exemplary embodiments link those collaboration tools 305 to the voice call, the additional tools are easily added and a history is provided so even a late joiner to the call can get up to speed with the material that was shared.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for executing and organizing collaborative exchange during a voice communication session utilizing a user interface (UI), comprising:
establishing a voice call, such that participants are connected; and
transmitting and receiving audible content over a network for the voice call;
wherein a user interface, representing the voice call itself, is provided and is configured to allow collaborative exchange among participants of the telephone call;
wherein the voice call is placed without having to set up a meeting session to facilitate collaborative exchange or without having to set up a web conference to facilitate collaborative exchange;
wherein the user interface provides real time collaboration tools for collaboration exchange; and
wherein the collaboration tools do not have to be set up in advance.
